(19) United States
(12) Patent Application Publication
(10) Pub. No.: US 2011/0293453 A1
(43) Pub. Date: Dec. 1, 2011

(54) BALL VALVE DEVICE AND METHOD FOR FORMING A BALL RETAINER IN A CHECK VALVE

(76) Inventors: Marco DE BERNARDI, Busto Arsizio (IT); Vagliviello Pietro, Cairate (IT)

(21) Appl. No.: 13/013,360

(22) Filed: Jan. 25, 2011

(30) Foreign Application Priority Data
May 28, 2010 (IT) M12010A000974

(51) Int. Cl. F04B 43/00; F16K 1/00; B21K 1/24

(52) U.S. Cl. 417/479; 29/890.132; 251/318

(57) ABSTRACT

The ball valve device comprises a tubular body in metal material, having a cylindrical wall conformed with cup-shaped internal protrusions to retain a ball shaped valving member, preventing the same valving member to be entrained by a fluid flowing through the valve device. The internal protrusions are performed by radially deforming inwards the cylindrical wall of the tubular body at one or more angularly spaced apart deformable areas. The tubular body provided with the ball retaining protrusions is suitable for any valve device, such as ball check valves pumping units for and/or ducts.

### BACKGROUND OF THE INVENTION

The present invention refers to a valve device and a method for making internal protrusions into a metal tubular body of a valve device, to retain a ball shaped valving member in an axial direction of the valve device, for example in check valves, or valve devices of any type, suitable for being arranged in ducts, pumping units, in order to retain the ball member, preventing the same from being entrained by the flowing fluid in an open condition of the valve device; the invention refers also to a check valve device of ball type comprising a tubular body provided with internal protrusions to axially retain a movable ball member, and its use in pumping units and in fluid circulation ducts.

### STATE OF THE ART

In a plurality of applications, for example in food, chemical and/or naval fields, use is made of check valves of ball type, enabling a fluid to flow in a prefixed direction, preventing the fluid from flowing backwards in a direction opposite to the previous one.

In general, a ball check valve comprises a valve body defining a flow path between an inlet and an outlet side for a fluid, in which a ball-shaped closure member is provided to axially move between a closed position against a sealing seat and an open position against internal retaining members or shoulder surfaces.

Ball check valves of the above mentioned type are known for example from GB 2287085, DE 102005012298 and JP 58124873.

In a plurality of technical fields in which use of check valves is made, a problem exists to prevent residues of fluid material from remaining on internal surfaces of the valve, or deposition at dead points, or undercuts, that could be cause of contamination.

In this regards, the roughness of the internal surface of the valve body, may also imply sometime a problem; furthermore, since the closure ball member of the valve device must be retained at the outlet side for the fluid, by providing proper retaining elements, for example internal protrusions by casting or machining the interior of the valve body, as disclosed for example in JP 58124873, GB 2287085 and DE 102005012298, some standards currently in force establish that the internal surface of a valve body exhibits adequately wide curvature radii, such to prevent deposition and residues of the flowing fluid from being formed inside the same valve device.

In pumping thick fluids, dual diaphragm pumps are frequently used provided with a system of ball check valves arranged and oriented for controlling the suction and delivery of the fluid, alternatively from branched out ducts of the same pump. In the case of pumping systems of this type, the pump assembly and the whole check valve system further require to be easily cleaned, in order to remove any possible residues of contaminated product without having to remove the pump assembly from a plant, or without having to dismount the entire check valves. Dual diaphragm pumps provided with a ball check valve system are shown for example in DE 102005012298 and U.S. Pat. No. 6,651,693.

In still other applications, a need may exist to dispose of a ball valve device conformed for enabling a controlled flow of a fluid along a duct, or through discharge openings, by preventing solid particles entrained by the fluid from passing through.

### OBJECTS OF THE INVENTION

A main object of the present invention is to provide a method for making a retainer or stops for a ball member in a valve device suitable for conveying and/or circulation of a fluid, by a very simplified solution of relatively reduced cost.

A further object of the invention is to provide a ball valve device, such as a ball check valve, conformed with internal ball retaining members that are free from sharp edges and/or undercuts to prevent the formation deposition of residual material and contamination of the flowing fluid.

A still further object is to provide a pump unit, for example a pump of dual diaphragm type, provided with ball check valves according to the invention, as well as to provide alternative solutions in manufacturing ball check valves of conventional type.

### SUMMARY OF THE INVENTION

According to the invention, a method has been provided for making a retainer for a ball member in a metal tubular body of a valve device, wherein a cylindrical wall of the tubular body is provided with one or more cup-shaped internal protrusions, suitable for preventing the ball member to be entrained by a flowing fluid, wherein the cup-shaped internal protrusions are formed by radially pressing and inwardly deforming the peripheral wall of the tubular body, at one or more deformable areas angularly spaced apart along an annular band.

According to another aspect of the invention a tubular body for a ball type valve device has been provided, in which the valve body is conformed with cup-shaped internal protrusions for retaining a ball member, according to the method of claim 1, as well as a check valve of the ball type according to claim 4, and a pumping unit comprising one or more ball check valves according to claim 8.

### BRIEF DESCRIPTION OF DRAWINGS

These and further features of the present invention, as well as some examples will be better apparent from the following description, with reference to the drawings, in which:

FIG. 1 is a longitudinal cross-sectional view according to line 1-1 of FIG. 2, of a metal tubular body of a valve device, suitable for illustrating the method for performing internal cup-shaped protrusions, according to the invention;

FIG. 2 is a cross-sectional view according to line 2-2 of FIG. 1, before the formation of the internal protrusions;

FIG. 3 is a cross-sectional view similar to FIG. 2, after the formation of the internal protrusions;

FIG. 4 is a longitudinal cross-sectional view of a ball check valve, according to the invention, in a closed condition;

FIG. 5 is a longitudinal cross-sectional view of the check valve of FIG. 4, in an open condition;

FIG. 6 shows an assembly of a diaphragm pump assembly comprising ball check valves according to the invention.

### DETAILED DESCRIPTION OF THE INVENTION

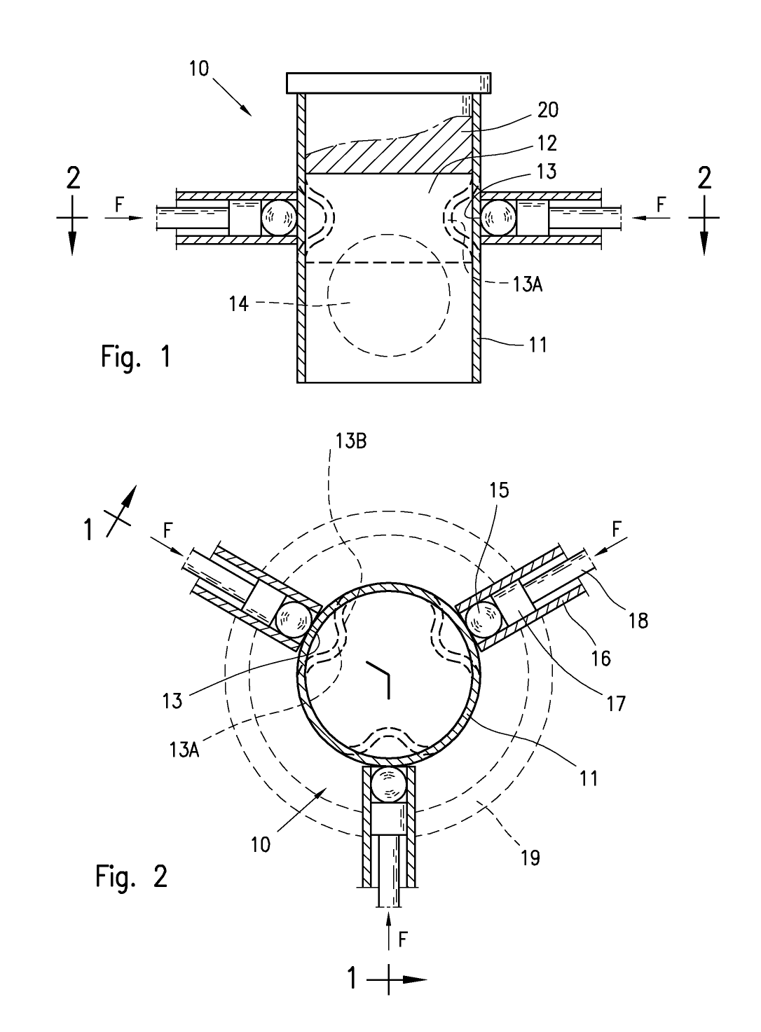

With reference to the FIGS. 1 to 3, the general features will be now described with reference to a tubular body suitable for a check valve device of ball type according to the invention, and a related method for performing ball retaining members inside the tubular body of the valve device.

In FIG. 1, a tubular metal element has been indicated with the reference number 10, suitable for providing the tubular body of a ball valve device. The tubular body 10 comprises a cylindrical wall 11 extending along a longitudinal axis, wherein the wall 11 comprises one or more angularly spaced apart deformable areas 13 along an annular band, at which areas 13 cup-shaped internal protrusions 13A must be made by a simple deformation caused by radially and inwardly pressing said deformable areas of the cylindrical wall 11, suitable for constituting a retainer or stop elements for a ball member 14 axially movable within the tubular body 10, and wherein the minimal angular space existing between the internal protrusions 13A is smaller than the diameter of the ball 14.

The protrusions 13A may be conformed anyway by radially pressing and deforming the cylindrical wall 11 of the tubular body 10, according to specific requirements of use; in the case of FIGS. 1 to 3, the formation of cup-shaped or hemispherical protrusions 13A has been shown having a curvature radius smaller than the diameter of the ball 14, the surface of said cup-shaped protrusions being gradually merging with the inner surface of the cylindrical wall 11, i.e. with connecting regions 13B having a curvature radius substantially similar to the radius of said protrusions, in order to prevent formation of sharp edges and/or undercuts.

The radial deformation of the areas 13 for the protrusions 13A along a peripheral band 12 of the cylindrical wall 11 of the valve body can be carried out in any suitable manner, by using any pressing device conformed for causing a radial deformation inwards the wall 11 of the valve device. In the example of FIGS. 1 to 3, wherein the valve body comprises three internal protrusions 13A, angularly spaced apart by 120°, the pressing device comprises at each deformable areas 13, a spherical pressing member 15, slidably housed within a tubular guide 16 which is radially oriented with respect to the cylindrical wall 11 of the tubular body 10. A thrust member 17, inside the tubular guide 16, pushes on the spherical pressing member 15 with a force F so as to cause the area 13 to be radially deformed inwards under the shape of a cup protrusion having a mean curvature radius substantially equivalent to the curvature radius of the same pressing member 15.

The thrust member 17 rearwardly extends with a stem 18, to apply the force F, which stem 18 can be manually actuated for example by a screw device, not shown, or by a hydraulic or pneumatic actuator, or actuator of any other suitable type. Preferably, three tubular guides 16 are mechanically connected to each other, as shown by 19, so that the resultant of the three forces F oriented towards the longitudinal axis of the tubular body 10 is substantially null; consequently, a central symmetry deformation is obtained for the internal protrusions 13A.

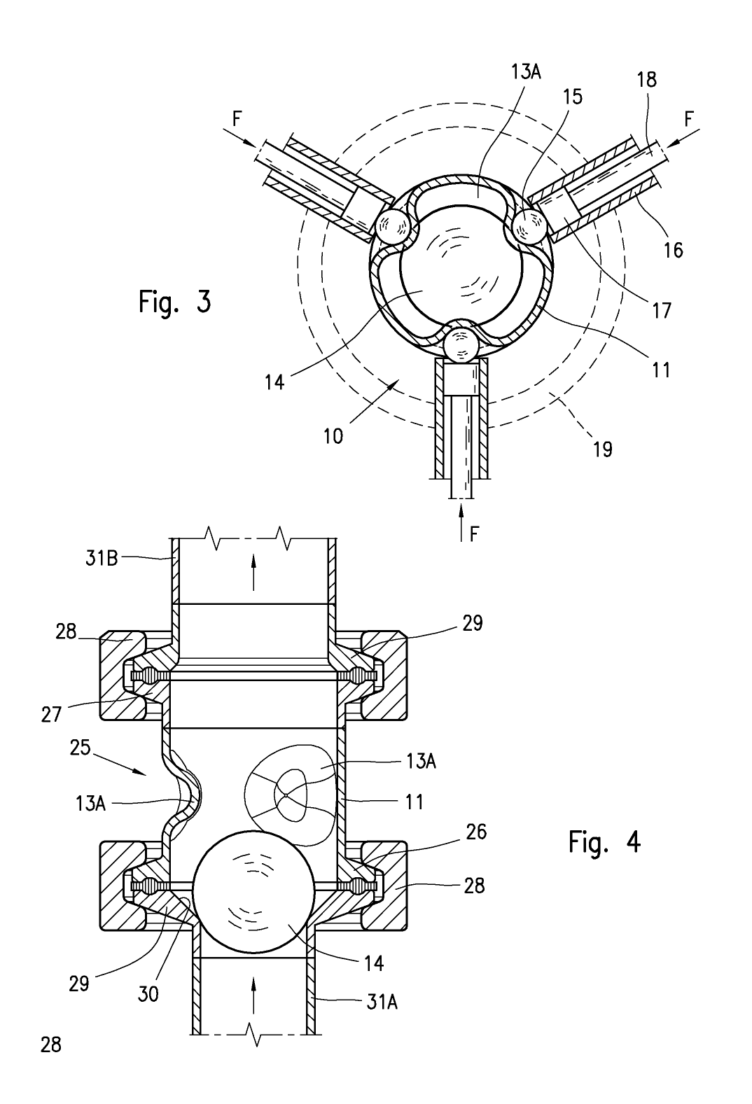

In FIG. 3, the result of the radial pressing operation of the deformable areas 13 for the internal protrusions 13A is shown, wherein the same reference numbers of FIGS. 1 and 2 are used to indicate similar or equivalent parts.

In order to prevent that one or both ends of the tubular body 10 become oval, or lose their circular shape during press-forming of the cup-shaped protrusions 13A, according to another aspect of the invention, after the band 12 and the deformable regions 13 of the wall 11 have been defined, a cylindrical counteracting plug member 20 is fitted into one or both ends of the tubular body 10, FIG. 1, said counteracting plug member 20 having a diameter substantially equivalent to or slightly smaller than the internal diameter of the tubular body 10. The counteracting plug member 20 axially extends, by a prefixed length, from a corresponding end of the tubular body 10, up to tangentially terminate at the deformable areas 13, i.e. at the end of the annular band 12. The counteracting plug member 20 could also be missing when the length of the tubular body 10 is such that the press-forming of the cup-shaped protrusions 13A on the band 12, does not cause the end portions of the tubular body 10 to be deformed.

Thus, according to the invention, after having determined the positions of the annular band 12 and the deformable areas 13, as well threading of the counteracting plug member 20, if necessary, into one or both ends of the tubular body 10, the tubular body 10 is positioned within the press-deforming device; radial forces F are progressively applied to the deformable areas 13 to cause the internal cup-shaped protrusions 13A to be formed with the desired shape and dimensions; the possible presence of the internal counteracting plug member 20, prevents the corresponding end of the tubular body 10 from become oval or deformed.

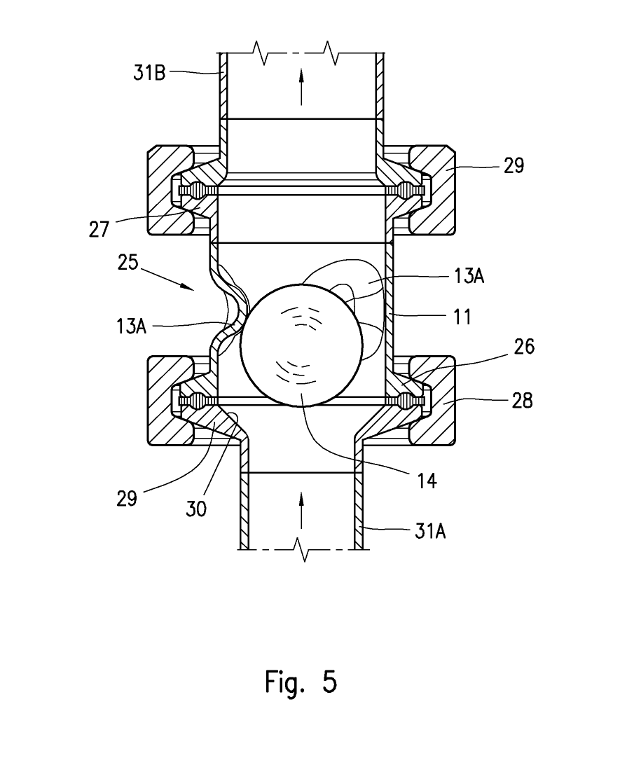

When the radial deformation of the wall 11 has ended, the tubular body 10 with the so formed internal protrusions 13A, can be removed by loosening the forces F, in order to successively subject said tubular body to other mechanical operations, for example for forming end joining portions of a valve body as described in the following, with reference to FIGS. 4 and 5, where the same reference numbers as in the previous figures are always used, for indicating similar or equivalent parts.

In FIGS. 4 and 5 a ball check valve device is shown, and has been indicated as a whole with the reference number 25; the valve device 25 again comprises a valve body having a cylindrical wall 11 conformed with internal hemispherical or cup-shaped protrusions 13A, obtained by radial deformation as in the case of the tubular body 10 previously described.

The cylindrical wall 11 of the valve body, at each end thereof, is conformed or provided with a joint or connection element 26, 27 of any suitable type, for example consisting of a thread joint or an annular flange, as shown, for allowing a sealing connection, for example by a clamp 28, with a flange 29 of a connection piece to a duct 31A, in which the flange 29 is provided with a conical sealing seat 30 for the closure ball member 14, respectively with corresponding flange 29 for a connection piece to a duct 31B for the circulation of a fluid, or for connection to any hydraulic apparatus.

The FIG. 4 shows the valve device 25, with the ball member 14 in closed position against the valve seat 30, whereas the FIG. 5 shows the valve device 25 in an open condition in which the ball member 14 is retained by the internal protrusions 13A, enabling thus the fluid to circulate along wide arc-shaped passageways existing between adjacent protrusions 13A, as shown in the cross-sectional view of FIG. 3; accordingly, also in FIG. 5 the same reference numbers were used as in FIG. 4, in order to indicate similar or equivalent parts.

The example of FIGS. 1 to 3 relates to a particular tubular body 10 conformed with cup-shaped internal protrusions 13A obtained by radially pressing deformable areas of the peripheral wall 11 of the tubular body 10, suitable for providing a valve device comprising a ball-shaped closure member that, in the open condition of the valve prevents said closure member from being entrained by the fluid, as retained by the protrusions 13A; furthermore, the example of FIGS. 4 and 5 shows a ball check valve obtained from the tubular body 10 of FIGS. 1-3, according to the invention.

In both cases, the resulting valve device is suitable for operating in a vertical disposition in order to enable the ball member 14 to fall down under its own weight when an upstream pressure, or a downstream vacuum pressure is missing, or when the entraining effect of the fluid circulating through said valve device is missing. However, other applications and/or arrangements of the valve device are possible, by orienting said valve device in any slanted or horizontal condition, use being provided, in this case, of a counteracting spring, not shown.

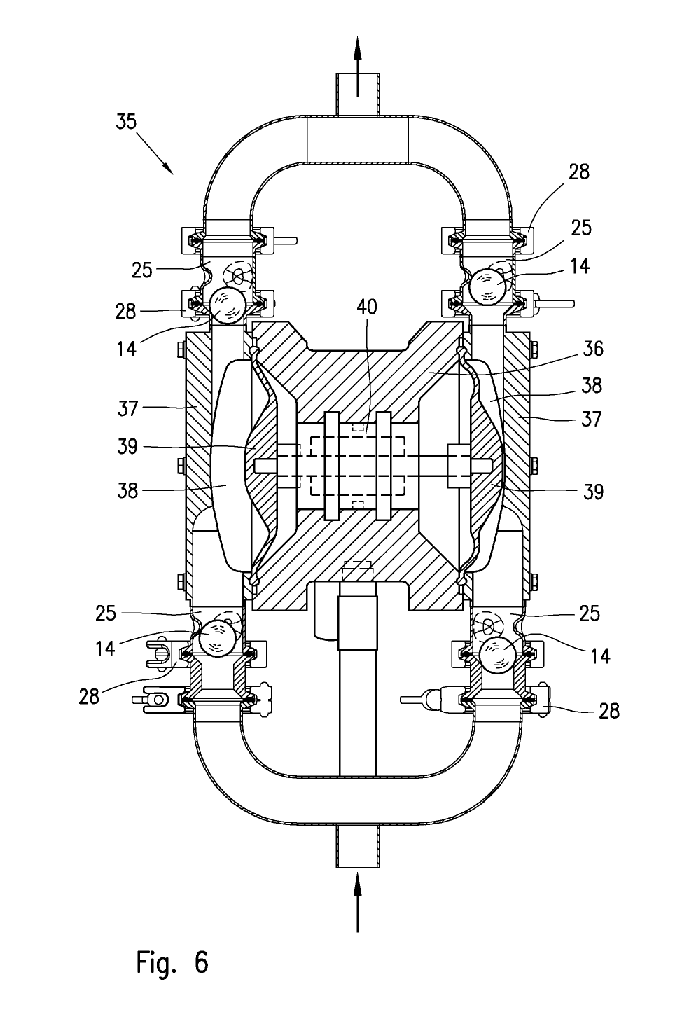

Lastly, by way of example, FIG. 6 shows a pumping unit, in particular a dual diaphragm pump assembly, comprising four check valves 25, according to the present invention, within intake and delivery ducts; a pump unit like that results particularly suitable for use in food or chemical fields or in other technical fields in which thick fluid should be fed.

The dual diaphragm pump unit, indicated as a whole by reference number 35, comprises a central body 36 and two lateral bodies 37, each lateral body 37 defining a pumping chamber 38 closed by a flexible membrane 39 of circular shape. A linear actuator 40 of double-acting type, with relative slide valves for switching the fluid under pressure in order to control the reciprocating movement of the pump, is positioned in the central body 36. As shown, the pump unit 35 comprises, both at intake and delivery sides of the two pumping chambers 38, a ball check valve 25 of the type previously described with reference to FIGS. 4 and 5.

The combination of a pumping unit, in particular the dual diaphragm pump 35, with ball check valves according to the invention, results very advantageous since enables the entire pump unit to be rapidly installed and/or removed, as well as the pump unit and the same valves to be easy cleaned, by simply acting on the tightening clamps 28.

Consequently, the shown solution results very advantageous owing to the following reasons:

it enables the ball-retaining cup-shaped members 13A to be obtained by a simple mechanical deformation of the body of a tubular element 10, preventing thus the use of additional retaining elements;

it enables the retaining members 13A to be conformed with a required hemispherical or cup shape the internal surface of the tubular body 10 by gradual curvature radii, suitable for preventing sharp edges or undercut portions, i.e. such to remove or substantially reduce any risk of deposition of encrustation of the product or conveyed fluid;

it eventually enables different types of valve device to be designed, suitable for any application.

Consequently, all was said and shown in the enclosed drawings is intended to have been given by way of example only, and other modifications or variations can be produced without thereby departing from the enclosed claims.

1. A method for performing a valve device comprising a tubular metal body having a cylindrical wall provided with internal protrusions for retaining an axially movable ball-shaped valving member, comprising the steps of:
defining one or more deformable areas on an annular band of the cylindrical wall of the tubular body;
positioning said tubular body with at least one of the deformable areas aligned to a pressing member of a deforming device; and
conforming cup-shaped protrusions inside the tubular body by radially pressing and deforming the cylindrical wall of the tubular body at one or more of said deformable areas along the annular band.

2. The method according to claim 1, comprising the steps of positioning an internal counteracting plug member, into at least one end of said tubular body to prevent deformation at said one end during conformation of the cup-shaped protrusions at the deformable areas of the cylindrical wall.

3. The method according to claim 2, wherein the internal plug member extends up to said internal protrusions of the tubular body, at one end of said annular band.

4. A ball valve device comprising a tubular body, having internal cup-shaped protrusions performed according to the method of claim 1, for retaining a ball-shaped valving member axially movable in the tubular body of the valve device wherein the tubular body comprises one or more cup-shaped internal protrusions at deformable areas of a cylindrical wall.

5. The ball valve device according to claim 4, comprising cup-shaped protrusions in correspondence of angularly spaced apart deformable areas of an annular band of said cylindrical wall.

6. The ball valve device according to claim 5 suitable for a check valve comprising:
a tubular body defining a flow path between an inlet and an outlet ends for a fluid;
a ball-shaped valving member inside the valve body, the valving member being movable between a closed position against a seat and an open position against cup-shaped protrusions inside the tubular body of the check valve;
said tubular body having annular flanges at said inlet and outlet ends;
a valve connecting element at each of said inlet and outlet end of the tubular body, each of said connecting element having a flange; and
clamping means for clamping the flanges of the tubular body to flanges of the valve connecting elements.

7. The valve device according to claim 6, wherein the cup-shaped protrusions are merging with an internal surface of the tubular body, by an intermediate internal surface having a curvature radius equivalent to the curvature radius of said cup-shaped protrusions of the body of the valve device.

8. A pumping unit comprising at least one pumping chamber having inlet and outlet sides for a fluid, wherein at each of said inlet and outlet sides the pumping unit comprises a check valve, said check valve comprising:
a tubular body defining a flow path between an inlet and an outlet ends for a fluid;
a ball-shaped valving member inside the valve body, the valving member being movable between a closed position against a seat and an open position against cup-shaped protrusions inside the tubular body of the check valve;
said tubular body having annular flanges at said inlet and outlet ends;
a valve connecting element at each of said inlet and outlet end of the tubular body, each of said connecting element having a flange; and
clamping means for clamping the flanges of the tubular body to flanges of the valve connecting elements.

9. The pumping unit according to claim 8, wherein the pumping unit comprises in a double acting diaphragm pump.
